(19) United States
(12) Patent Application Publication
(10) Pub. No.: US 2019/0177189 A1
(43) Pub. Date: Jun. 13, 2019

(54) INSTALLATION FOR OBTAINING PHOSPHATE SALTS AND METHOD FOR OPERATING THIS INSTALLATION

(71) Applicant: Fraunhofer-Gesellschaft zur Förderung der Angewandten Forschung e.V., Muenchen (DE)

(72) Inventors: Siegfried EGNER, Adelsheim (DE); Iosif MARIAKAKIS, Stuttgart (DE)

(21) Appl. No.: 16/327,490

(22) PCT Filed: Mar. 1, 2018
(86) PCT No.: PCT/EP2017/071132

§ 371 Date: Feb. 22, 2019

(30) Foreign Application Priority Data
Aug. 22, 2016 (DE) 10 2016 115 554.3

(51) Int. Cl. C02F 1/461; C02F 3/12; C02F 11/121; C05B 9/00

(52) U.S. Cl. CPC C02F 1/46176; C02F 3/1215; C02F 11/121; C02F 1/46109; C02F 2101/105; C05B 9/00; C02F 2001/46133; C02F 2001/4619; C02F 1/4618

(57) ABSTRACT

The invention provides an installation (10) for separating phosphate from phosphate-containing liquids and obtaining phosphate salts, having one or more reactors (12) which each have two electrodes of opposing polarity and which, between them, span a reaction area, wherein each reactor (12) has an inlet (14) and an outlet (16), in which the outlet (16) is separated into a recirculation (22) and a discharge stream (24) and the recirculation (22) supplies part of the liquid from the outlet (16) of the reactor (12) to the inlet of the same reactor or a different reactor (12); and to a method for this and to a biological wastewater treatment plant and to a method for operating the latter.

The invention relates to an installation for obtaining phosphate salts (in particular MAP or KMP) from phosphate-containing liquids, for example processing water or wastewater, using one or more reactors that each comprise two electrodes of opposing polarity and that span a reaction area between them, wherein each reactor has an inlet and an outlet.

The elements nitrogen, potassium and phosphorous are, among others, elements essential for plant growth. These are mostly contained as ions in solid or liquid organic wastes or wastewater. For the treatment of these wastes or wastewaters, e.g. municipal wastewater, these materials must be extracted for protection of the environment, on the one hand. On the other hand, it is also important in terms of sustainability to recover them and make them available again as plant fertilizer. It is therefore important to transform nitrogen and phosphate into an inorganic form suitable for use as fertilizer, for example via precipitation as MAP or KMP. Phosphate salts such as magnesium ammonium phosphate (MAP) or potassium magnesium phosphate (KMP) are high-value plant growing aids for which there is a high demand.

The spontaneous precipitation of MAP or KMP is limited by the typically low magnesium concentration. The addition of magnesium hydroxide, magnesium oxide or water-soluble magnesium salts for MAP precipitation is known. With the addition of magnesium hydroxide or magnesium oxide, for example to the wastewater or other organic residual materials to be treated, these compounds dissolve only very slowly and often only at a low concentration. The result of this is that it must be continuously stirred or recirculated, which, however, requires an additional expenditure of technology and energy and thus also of costs. Moreover, because of their poor solubility, the two compounds must be superstoichiometrically overdosed, because, otherwise, an incomplete precipitation of the desired plant growing aids occurs and significant quantities of phosphate, for example, remain in the wastewater. If magnesium salts are released in a solution in advance, the efficiency of the method is diminished by the dilution with water.

The optimal pH value for the precipitation of MAP is 8.5-9, for KMP the value is even higher. The present wastewater and process water solutions usually have pH values between 5 and 7. For this reason, an alkali is frequently added in the prior art to raise the pH value. An additional possibility for an adjustment of the pH value that is advantageous for precipitation is noted in DE 101 12 934 B4. The aeration through digested sludge with subsequent CO₂ stripping mentioned therein is investment- and energy-intensive, however, and therefore causes high additional costs.

In addition, it is also previously known from DE 10 2010 050 692 AI, for example, to provide a reactor for separating salts containing phosphate, wherein an electrochemical reaction is provided and one of the electrodes comprises magnesium or a magnesium-containing material as a sacrificial anode. A relatively small DC voltage is thereby applied so that the liquid containing the phosphate and ammonium is supplied with magnesium ions and, finally, the pH value is increased in a known manner and the reactions necessary for precipitation can take place. The costs for the operation of the installation compared to the known methods are already lowered by means of the low energy requirement.

In the prior art, such installations are generally implemented as reactors connected in series (tubular reactor) that must be operated using a minimum necessary flow rate and, thus, throughput to prevent deposits by sedimentation, for example. Depending upon the phosphate concentration, the number of reactors arranged in series, thus the length of the installation, and with it the minimum dwell time of the liquid in the reactor, must be selected appropriately in order to supply sufficient magnesium ions. The disadvantage here is that the number of reactors connected in series depends upon this minimum speed or on the phosphate load to be reduced, and the operating mode is therefore not flexible.

Based on this prior art, the object of the invention is now to further improve the present installation and the method.

The invention achieves this object by an installation having one or more reactors, each comprising two electrodes of opposing polarity and spanning a reaction area between them, wherein each reactor has an inlet and an outlet and wherein the outlet is divided into a recirculation and into a discharge stream and the recirculation supplies a part of the liquid of the outlet of a reactor to the inlet of the same or a different reactor and an extraction device is provided for the phosphate salts.

In this way, it is possible for the liquid to be guided through a reactor and run through the electrochemical process multiple times until the quantity of magnesium ions necessary for the reduction of the phosphate has been released. This results in the principle of a mixing reactor. If a part of the reactor volume now runs through the reaction zone (reaction area) multiple times, the OH⁻ ions formed are accumulated, meaning their concentration is increased, so that the pH value can be increased, preferably to at least 8 or even at least 8.5 or even to 9.5 or more without the addition of alkali or another method of increasing the pH value and the precipitation of MAP and/or KMP is possible or supported. As a result, the number of reactors connected in series is advantageously independent of the phosphate load supplied and to be reduced.

According to (G1.1), the liquid containing phosphate and ammonium is supplied with magnesium ions at the anode. At the cathode, water is used, wherein hydrogen escapes from the system and the pH value is increased by the OH⁻ ions (G1.2).

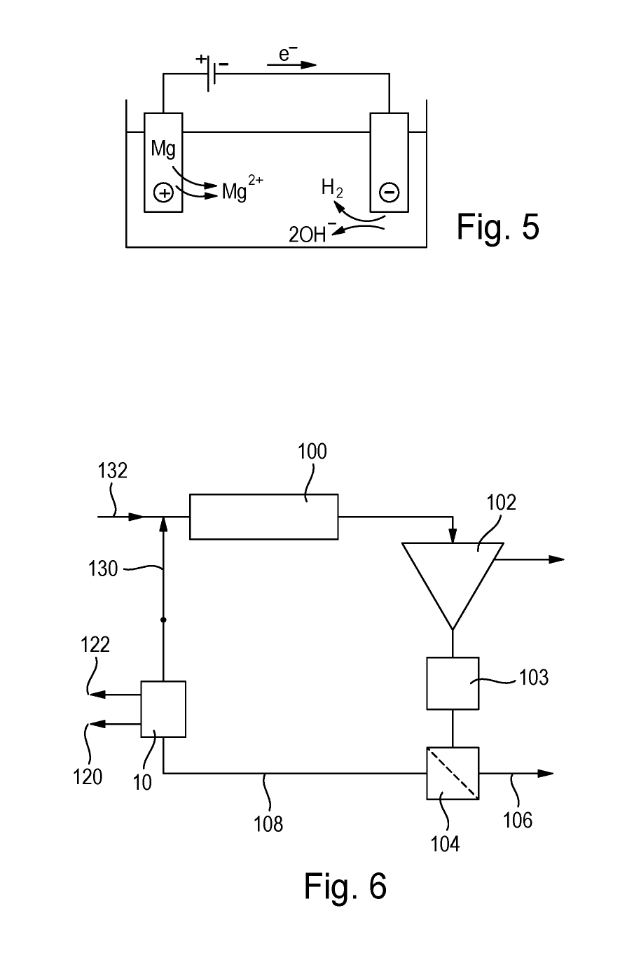

The ongoing reaction is represented in FIG. 5.

The reaction equations are:

Mg₍ₛ₎—Mg²⁺+2e−

2HₛO+2e−H_{2(g)}+2OH—

where (s)=solid and (g)=gaseous

Crystal formation occurs in the presence of ammonium and phosphate from the material flow to be processed, according to the following reaction, for example:

Mg²⁺+NH₄₊+PO₄³⁻+6H₂O MgNH₄PO₄6H₂O₍ₛ₎

Because the reduction of the amount or concentration of phosphate now is no longer accomplished via a number of reactors running in series that is dictated by the phosphate load to be reduced, the flow speeds that can be achieved are increased by the recirculation flow. This is especially preferred because a better mixing of the liquid and with it an intensification of the reaction thus occurs in the reaction zone between the electrodes because of the highly turbulent flow. In particular, a deposition of phosphate crystals that are created can be prevented by increasing the flow speeds. Advantageously, a flow speed prevails in the reactor such that the resulting salt crystals are further transported and do not sediment.

The discharge of the salt crystals from the system (installation) can already take place early, in particular downstream of each reactor, at a reaction rate and efficiency that are nevertheless higher because the amount of MAP or KMP recoverable in each reactor is increased compared to the tubular reactor design according to the prior art. With a parallel arrangement in reactors, the separation of the crystals can be accomplished via a common extraction device. Basically, the crystals can also be separated only downstream of a plurality of reactors connected in series or downstream of each reactor.

It can preferably be provided that the outlet of one or more reactors can open out into a storage tank from which the recirculation again branches.

It can be provided that the recirculation and/or the outlet, in particular of the storage tank, has an extraction device for the resulting phosphate salts. The extraction device can be arranged on the suction or the pressure side of a pump provided in the recirculation. In particular, a crystal separation unit such as a sedimentation basin or a filter can be provided as an extraction device.

The recycling of the recirculation can thus take place in the respective or also in a different reactor.

Moreover, the increase of the pH value offers the advantage that a deprotonation of the ammonium to ammonia occurs in liquids containing ammonium according to

NH₄⁺+OH⁻↔NH_{3(g)}+H₂O

The ammonia formed becomes volatile and can be supplied for a further use together with or separate from the hydrogen being released. Because ammonium is generally present in a many-times higher concentration than phosphate and only a part of the ammonium can thus be removed in the precipitation of MAP, the additional, particularly preferred task of removing ammonium compared to the nitrogen is also achieved. It is thus advantageous that the removal of phosphorous in the form of phosphate salts and of nitrogen in the form of liquid ammonia takes place in one installation and no additional installations need to be provided. In particular, both materials are formed simultaneously and preferably also separated simultaneously.

In order to use this, it can therefore preferably be provided that the reactor, the outlet and/or the recirculation has a unit to collect and separate gasses from liquids. In particular, it can be provided that ammonia together with hydrogen is drawn off for material and/or energy recycling purposes, either in the outlet and/or the recirculation, for example in combination with the crystal separation or directly via a collection chamber integrated within the reactor.

In particular, it can also be provided that a processing unit for degassing ammonia from the product stream as well as for separating ammonia and recovering ammonium fertilizer can be provided downstream of each reactor or only downstream of a series of reactors or a number of parallel reactors.

In particular, it is provided that the installation is operated in such a manner that, in addition to the required flow speed for preventing undesired deposition of crystals and, with respect to the number of the reactors, in order to be independent of the phosphate load supplied and to be reduced, the installation inlet amount (flow) (Q_{D}) and the recirculation amount (Q_{R}) are adjusted to each other in such a way that the pH value reaches a value pH ≥8, in particular pH ≥8.5 preferably ≥9 at a desired position and, thus, in addition to the particularly efficient crystallization of phosphate salts, the segregation of ammonia is promoted, in particular via the high flow speeds and accompanying turbulence that are prevalent in the reaction area of at least one reactor.

A pump is preferably provided in the recirculation here. This can serve as a mixing device for the mass stream. Additional pumps can be provided in the inlet and/or discharge stream, for example.

Particularly preferably, it can be provided that one or more reactors in an installation are connected in series and/or in parallel. Combinations are also possible here. In this way, two or more reactors can be connected in parallel, for example in order to then be arranged in series with additional reactors. The recirculation and, as appropriate, also the gas or crystal separation can be arranged so that it is provided for each individual reactor. However, reactors can also be arranged in parallel or in series, wherein the recirculation leads to the inlet of the first or a previously series-connected reactor or feeds the inlet of a plurality of reactors connected in parallel. In addition, it is also possible to choose a cascaded structure, wherein the recirculation is again supplied to either the same or a previous stage. Depending on which recirculation is created, the necessary pH increase of a reactor can be adjusted or achieved individually or the pH increase of a plurality of reactors can be influenced collectively.

It is especially preferred here if the ratio of flow and recirculation Q_{R}/Q_{D} is ≥1, in particular ≥2, in particular ≥3 and in particular ≥4 and preferably ≥5. This means that the flow of supplied liquid in the inlet to the flow in the recirculation is configured so that at least as much recirculate as inlet is guided to the reactor. The flow of the recirculate is preferably larger than the flow of the inlet.

With the installation described here, phosphate salts can be efficiently recovered for the fertilizer industry as well as any possible ammonia that can also be further processed into fertilizer. As in the prior art, it can also thus be provided that one of the electrodes is in particular a sacrificial electrode made of material containing magnesium, so that MAP or KMP can be formed.

The invention further relates to a method for separating phosphate from phosphate-containing liquids, for example process water or wastewater, in particular MAP and KMP, wherein the liquid is supplied via an inlet of a reactor and leaves it via an outlet, and precipitated phosphate salts are drawn off via an extraction device. It is also provided that an outlet stream is separated into a discharge stream and a recirculation stream, and the recirculation stream is again supplied to the inlet (flow) of the same or a different reactor. In this manner, given an appropriate adjustment of the ratio of the recirculation stream to the inlet stream wherein a rate of at least 1, preferably, however, at least 2, preferably at least 3, more preferably at least 4 and more preferably at least 5 is preferred, the pH value is preferably set to ≥8, in particular to ≥8.5 and preferably to ≥9, so that, in addition to a preferred high flow speed, a particularly efficient phosphate salt precipitation occurs, or, where appropriate, hydrogen as well as liquid ammonia can be separated and recovered for the fertilizer industry or used for energy purposes.

Particularly advantageously, such a method and such a device can be used in the context of municipal wastewater treatment plants as well as other biological sewage treatment installations. The invention therefore also relates to the implementation, meaning use of the process in a biological wastewater treatment plant, as well as the biological wastewater treatment plant comprising a biological stage, a biomass separation and a dewatering of the biomass (sewage sludge) connected downstream of the biomass separation. The sewage sludge here is supplied to a sludge dewatering in particular, and a filtrate water stream is created that is supplied to the inlet of the biological stage. This filtrate water stream is generally loaded with phosphorous and nitrogen. The ratio of ammonium and phosphorous in the process water of a biological wastewater treatment plant (municipal, for example) is not equivalent in the filtrate water. An anaerobic processing step can preferably be provided between the biomass separation and the dewatering to reduce and stabilize the biomass. The phosphorous and ammonium present in the biomass are released via this anaerobic step so that the load of N and P in the filtrate water is increased compared to a wastewater treatment plant without this anaerobic step.

Typically, 15 to 20 times more ammonium is present than phosphorous. In the formation of MAP for obtaining phosphorous, meaning magnesium ammonium phosphate, ammonium is extracted only at equimolar quantities as phosphorous. Significant ammonium thus remains in the filtrate water that is circulated in the wastewater treatment plant and must be aspirated in the biological stage. Because the biological stage for this in a biological wastewater treatment plant is usually aerobic, atmospheric oxygen for this is required via the aeration, whereby the energy requirement of a wastewater treatment plant is significantly increased.

In addition, nitrogen as well as phosphorous also represent an important plant growing aid. Therefore, according to the invention, an installation for obtaining phosphate salts from phosphate-containing liquids as previously described is provided in the filtrate water stream having one or more electrolytic reactors that each comprise two electrodes of opposing polarity and that span a reaction area between them, wherein each reactor has an inlet and an outlet. In this arrangement, the outlet is divided downstream of a crystal separation device or a storage tank into a recirculation and a discharge stream and the recirculation thus conducts a part of the liquid of the outlet of the reactor back to the inlet of the same or a different reactor. An extraction device for the phosphate salts as well as a unit for collecting and separating gasses from liquids, in particular for the volatile ammonia, is further provided.

The invention further relates to a method for implementing the installation according to the invention in—and for operating—a biological wastewater treatment plant, in particular of the type described above, wherein precipitated filtrate water is supplied again to a biological stage, and wherein in an installation for obtaining phosphate salts the filtrate water is subjected to an electrolytic reaction in at least one reactor via a sacrificial anode containing magnesium in order to obtain phosphate salts from the filtrate water, wherein the filtrate water is supplied for this purpose via an inlet to the at least one reactor and leaves it again via an outlet after flowing through the same, and precipitated phosphate salts and volatile ammonia are drawn off via an extraction device.

The formation and the separation of ammonia, phosphate salts, and the resulting hydrogen occurs in particular in an installation and in particular simultaneously.

The installation and the method for operating the installation can be designed here as described above.

The invention is explained below in reference to a drawing.

Shown are:

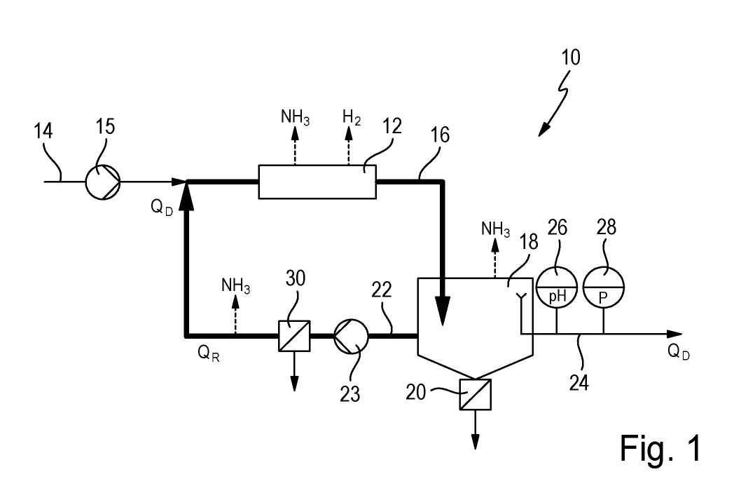

FIG. 1 an installation according to a first embodiment,

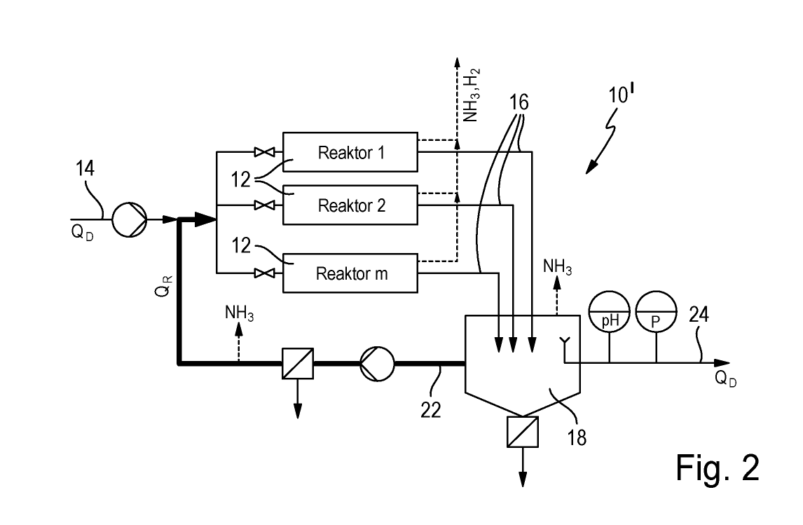

FIG. 2 an alternative embodiment of the installation having reactors connected in parallel,

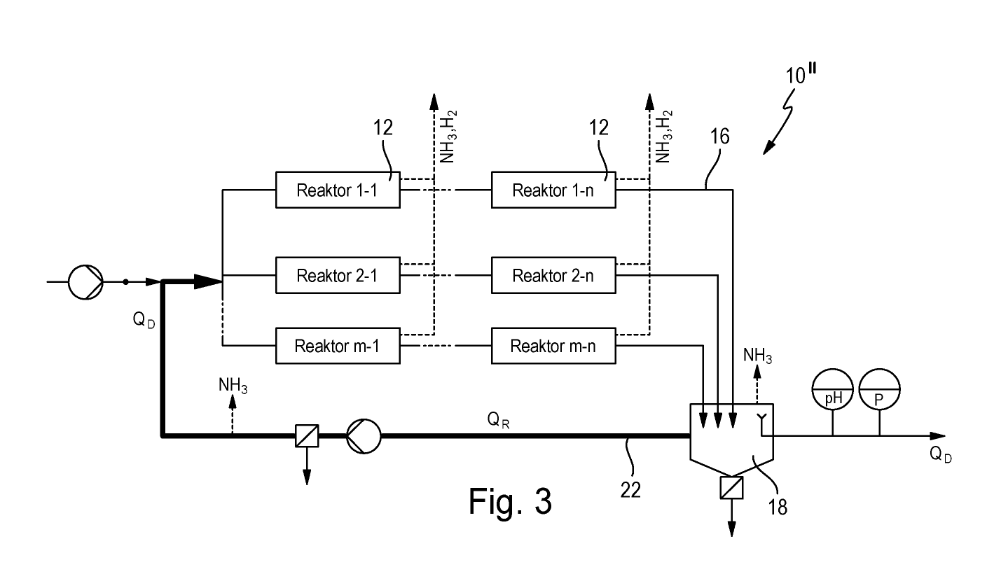

FIG. 3 an additional embodiment of the installation having reactors connected both in parallel and in series,

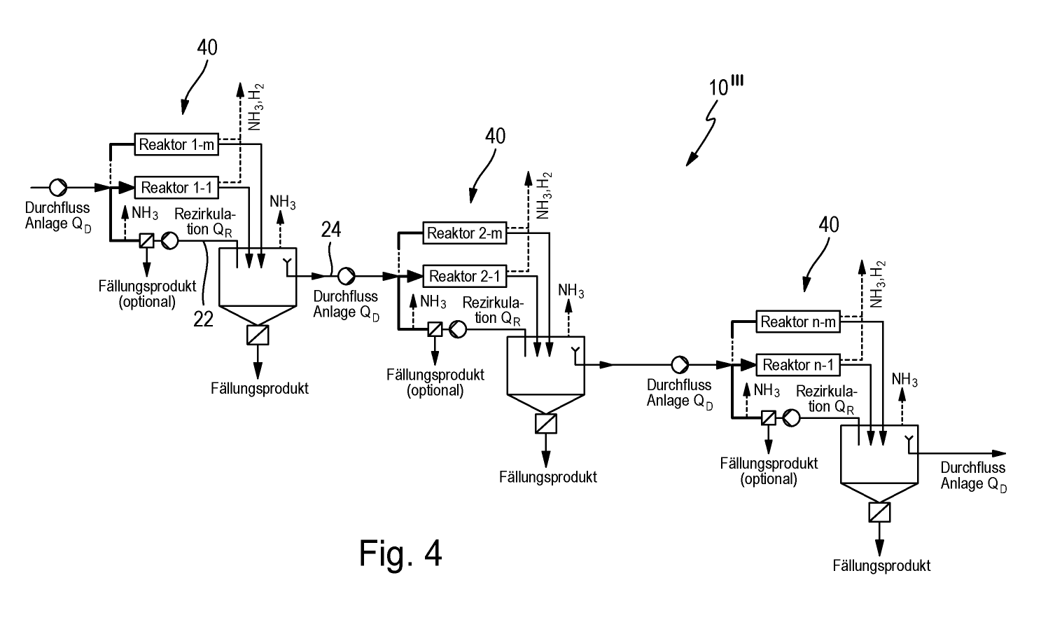

FIG. 4 a cascaded connection of the installation,

FIG. 5 a schematic for the electrolytic reaction,

FIG. 6 a schematic representation of a biological wastewater treatment plant according to the invention.

FIG. 1 shows an installation according to a first embodiment that is provided as a whole with the reference character 10. The installation comprises a reactor 12 having an inlet 14 and an outlet 16. The reactor 12 is an electrolytic reactor in which phosphorous from phosphorous-containing liquids can be crystallized out in particular into MAP or KMP via the consumption of a sacrificial anode made of magnesium. This can take place in a purely galvanic manner or with the application of a current. The flow in the region of the inlet 14 is indicated with QD.

The pH value of liquids, in particular wastewater and other liquids containing phosphorous, is approx. 5 to 7. By means of the electrolytic conversion in the reactor (see FIG. 5), OH⁻ ions are released so that the pH value in the reactor increases. The pH value upstream of the reactor 12 is therefore lower than downstream of the reactor 12.

The outlet 16 now leads into a storage tank 18, to which is connected a crystal separator 20, via which the phosphate salts can be drawn off. A partial stream of the outlet 16 is then combined with the inlet 14 and resupplied to the reactor 12 as recirculation 22. The flow in the recirculation 22 is indicated here with Q_{R}. Q_{R} is preferably Q_{R}≥5×Q_{D}.

An additional part of the outlet 16 is extracted from the installation 10 as discharge stream 24, wherein measurements are taken here of the pH value using a probe 26 and of the phosphorous using a probe 28, and the discharge stream in turn has a flow of QD. The pH value at discharge stream 24 is ≥8 to 9.5 or above. The pH value is again increased compared to a one-time passage through the repeated exposure in the reactor 12 by means of the circulation of a part of the outlet 16 because there is a concentration of OH⁻ ions (see FIG. 5). A supplementary addition of alkali can therefore be omitted.

In particular, the flow speed can be adjusted so that the best-possible mixing and reaction takes place in the reactor 12 and an unwanted sedimentation of salt crystals is prevented.

In addition or alternatively to the crystal separator 20 in the storage tank 18, a separation can also take place in the recirculation 22, for example, wherein this separation is provided with the reference character 30.

Pumps 23 or 15 are provided in the recirculation 22 as well as in the inlet 14.

Moreover and particularly advantageously, through the recirculation and the increase of the pH value, it can be achieved that the ammonia (NH₃) and the hydrogen (H₂) present are volatile and can be drawn off, for example, in the reactor 12 and/or via the storage tank 18 and/or in the region of the recirculation 22 as indicated respectively with arrows. These two products can be further reprocessed materially and/or for energy purposes.

In contrast to this simplest form of the installation according to the invention, FIG. 2 shows an installation 10′, in which n reactors 12 are connected in parallel. The outlet 16 of all of the reactors 12 is supplied to a storage tank 18 from which the recirculation 22 is supplied, which is in turn fed to the inlet 14 of the installation 10′. In this manner, the total output of the installation 10′ can be increased without having to change the individual reactors 12. A continuous operation is additionally possible in this manner, insofar as individual reactors 12 must be disconnected and exchanged, for example because of the consumption of the electrodes.

FIG. 3 now shows an additional embodiment of the invention, wherein, as a modification of FIG. 2, the reactors 12 of the installation 10″ are connected not only in parallel, but also in series, wherein a series comprises up to n reactors 12 and up to m reactors are connected in parallel. Thus the outlet 16 of the n reactors arranged in series is then correspondingly supplied to the buffer reservoir 18, wherein this buffer reservoir 18 in turn feeds the recirculation 22. By virtue of the additional series connection of the reactors 12, in the course of the throughflow of the different reactors 1 to n there is as complete a conversion as possible of the phosphorous in the liquid to phosphate salts. The recirculation 22 is guided from the first reactor of the series into the common inlet 14 of all the parallel reactors 12. The remaining elements of the invention, in particular the removal of NH3 as well as H2 and the salts is analogous to the exemplary embodiment according to FIG. 1.

FIG. 4 shows a cascaded connection. In the cascaded connection of the installation 10′″ shown in FIG. 4, each cascade stage 40 is designed analogous to FIG. 2. The discharge stream 24 of a cascade stage 40 is thus simultaneously the inlet of the next cascade stage. In addition to the design of the recirculation 22 shown in the corresponding cascade stage 40, it is also possible to provide a recirculation in a previous cascade stage.

FIG. 6 shows a basic principle of a biological wastewater treatment plant comprising a biological stage 100, wherein the liquid leaving the biological stage is supplied to a biomass separation 102 in order to retain the biomass in particular. The biomass leaving the biomass separation 102 (sludge) is then separated in a step 104 (sludge dewatering) into a filtrate water stream 108 as well as a dewatered biomass (106). The filtrate water stream 108, which still contains nitrogen and phosphate, is supplied to a previously described installation 10 for obtaining phosphate salts and gaseous ammonia, wherein magnesium ammonium phosphate (MAP) 120 as well as ammonium in the form of ammonia 122 being released is preferably obtained in the installation 10.

Optionally, an anaerobic processing step 103 for reducing and stabilizing the biomass can be connected between the separation and the dewatering, which, however, also frees the phosphorous and ammonia contained in the biomass. As a result, the load of N and P in the filtrate water 108 is increased compared to a wastewater treatment plant without an aerobic processing step 103.

The liquid 130 (the discharge stream 24) present after leaving the installation 10 is largely free of ammonium and phosphorous or only has them in a sharply reduced amount. This discharge stream 24 of the installation 10 is then supplied again to the inlet 132 of the biological step 100 as treated filtrate water 130 and mixed with the inlet stream 132 so that the biological stage 100 is not loaded with phosphorous and nitrogen during the circulation, and in particular energy for removing nitrogen as N2 (aspiration) and phosphate is no longer needed.

The flow speeds can be increased by means of a corresponding installation for obtaining phosphate salts and preferably also ammonia from liquids that contain these materials, namely by repeated exposure of the liquid, so that a better mixing and thus more efficient reaction can take place and a sedimentation can be prevented at an earlier instant. A concentration of OH⁻ ions thus takes place so that the pH value increases significantly compared to a simple flowing through of the reaction chamber 12. In this manner, installations can be provided that make possible a particularly cost-efficient, perhaps even lucrative use of wastewater, such as wastewater from agriculture in particular, but also municipal water management. The implementation in a biological wastewater treatment plant is therefore particularly preferred.

1. An installation (10) for separating phosphate from phosphate-containing liquids and for obtaining phosphate salts having one or more reactors (12) that each comprise two electrodes of opposing polarity and that span a reaction space between them, each reactor (12) having an inlet (14) and an outlet (16), characterized in that the outlet (16) is separated into a recirculation (22) and a discharge stream (24), the recirculation (22) supplies a part of the phosphate-containing liquids from the outlet (16) of the one or more reactors (12) to the inlet (14) of a same one of the one or more reactor (12), or to another one of the one or more reactors (12), and an extraction device is provided for the phosphate salts.

2. The installation according to claim 1, characterized in that the outlet (16) of the one or more reactors (12) opens out into a storage tank (16), from which the recirculation (22) branches off.

3. The installation according to claim 1, characterized in that the one or more reactors (12), the recirculation 22 and/or the outlet (16), in particular the storage tank (18), has an extraction device for phosphate salts.

4. The installation according to claim 1, characterized in that the one or more reactors (12), the outlet (16) and/or the recirculation (22) have a unit for collecting and separating gasses, in particular hydrogen and/or in particular gaseous ammonia, from liquids, in particular liquids containing ammonium.

5. The installation according to claim 1, characterized in that the discharge stream (24), in particular downstream of a last reactor (12), has a pH value of ≥8, in particular ≥8.5, preferably ≥9.

6. The installation according to claim 1, characterized in that the one or more reactors (12) can be connected in series or in parallel.

7. The installation according to claim 1, characterized in that a ratio of a flow (Q_{R}) of the recirculation (22) to a flow (Q_{D}) of the inlet (14) is ≥1, in particular ≥2, in particular ≥3, in particular ≥4, in particular ≥5.

8. The installation according to claim 1, characterized in that one of the two electrodes is a sacrificial electrode that comprises in particular a material containing magnesium.

9. The installation according to claim 1, characterized in that the phosphate salts and volatile ammonia in liquids containing ammonia, and in particular also hydrogen, can be formed simultaneously and in particular can be simultaneously separated.

10. A method for separating phosphate from a phosphate-containing liquid using the installation according to claim 1, comprising one or more reactors for electrolytic reaction of phosphates in the phosphate-containing liquids to the phosphate salts, the phosphate-containing liquids being supplied to a reactor via the inlet (14) and leaving the inlet (14) via the outlet (16) and precipitated phosphate salts are drawn off via an extraction device, characterized in that an outlet stream is separated into a discharge stream and a recirculation stream, and the recirculation steam is supplied to the inlet (14) of a same one of the one or more reactors (12), or a different reactor and is mixed with this.

11. The method according to claim 10, characterized in that a ratio of the recirculation stream to the inlet stream is set a ≥1, in particular a ≥2, in particular ≥3, in particular a ≥4, in particular ≥5.

12. The method according to claim 10, characterized in that a plurality of reactors is arranged in series and/or in parallel.

13. The method according to claim 10, characterized in that the recirculation stream is set so that the pH value in at least one of the reactors becomes a ≥pH 8, in particular a ≥pH 8.5, preferably a ≥pH 9.

14. The method according to claim 10, characterized in that volatile ammonia is separated out from the outlet and/or the recirculation stream and/or the reactor.

15. The method according to claim 10, characterized in that the phosphate salts and volatile ammonia are formed simultaneously in the presence of liquids containing ammonium and, in particular, also hydrogen, and in particular are simultaneously separated.

16. A biological wastewater treatment plant comprising the installation (10) according to claim 1.

17. A biological wastewater treatment plant according to claim 16, further comprising a biological stage (100), a biomass separation (102) and a unit for dewatering the biomass (104) connected downstream of the biomass separation (102), a resulting filtrate water (24, 108, 130) being suppliable to an inlet stream (132) of the biological stage (100), characterized in that the installation (10) is arranged for obtaining the phosphate salts in the resulting filtrate water (108, 130), and the installation (10) having an extraction device (20,30) for the phosphate salts and a unit for collecting and separating ammonia.

18. A method for operating a biological wastewater treatment plant according to claim 16, the method comprising supplying again a filtrate water stream obtained after the biomass separation (102) and dewatering of a biomass to a biological stage, characterized in that the method comprising subjecting beforehand in the installation (10) for obtaining phosphate salts the filtrate water stream to an electrolytic reaction in at least one reactor of the installation via a sacrificial anode containing magnesium in order to obtain phosphate salts from the filtrate water stream, suppling the filtrate water stream to the one or more reactors (12) via the inlet (14) and then leaving the filtrate water stream via the outlet (16) and precipitated phosphate salts being drawn off via an extraction device, separating an outlet stream into a discharge stream and a recirculation stream in the installation, and supplying the recirculation stream to the inlet (14) of a same one of the one of more reactors (12) or a different reactor, and mixing the discharge stream with an inflow stream of a biological stage (100) and also ammonia becoming volatile and being separated in the installation for separating phosphate, in particular simultaneously.

19. The method according to claim 18, characterized in that the method comprises increasing the pH, via the setting of the ratio of the flow of the recirculation stream to the inlet stream, to ≥8, in particular ≥8.5 and in particular ≥9.0.

20. The method according to claim 18, characterized in that the method comprises setting a ratio of the recirculation stream to the inlet to a ≥1, in particular >2, in particular ≥3, in particular a ≥4, in particular >5.

21. An installation according to claim 1, wherein the installation is used in, or forms part of, in a biological wastewater treatment plant.
